(19) United States
(12) Patent Application Publication
(10) Pub. No.: US 2005/0098705 A1
(43) Pub. Date: May 12, 2005

(54) Method and facility for the automatic production of hollow bodies from mixed material

(76) Inventor: Johann Schlusselbauer, Altenhof (AT)

Correspondence Address: THE MAXHAM FIRM, 750 "B" STREET, SUITE 3100, SAN DIEGO, CA, 92101, US

(21) Appl. No.: 11/004,422

(22) Filed: Dec. 3, 2004

(30) Foreign Application Priority Data
Mar. 21, 2000 (DE) 100 13 824.1

(51) Int. Cl. B28B 21/00

(52) U.S. Cl. 249/184

(57) ABSTRACT

A method for the automatic production of hollow bodies from mixed material, particularly concrete. A mold assembled from a mold core comprising a shaking device, an exterior mold and a bottom sprue is positioned in a molding area, non-solidified bulk material, particularly unset concrete, is uniformly filled into the mold space between the mold core and the exterior mold, the mixed material is compressed by shaking, an upper centering end is formed by pressing an upper sprue into the unset concrete column and thereafter the so formed, still soft molded body is removed from the mold by extraction and is transported to a drying area. At least some of the mold components are automatically assembled in an assembly area previous to a mold exchange and moved into the molding area as a pre-mounted assembly. Previous to a renewed mold exchange they are reassembled in the molding area to form an independent assembly to be transported off. The invention also relates to a facility for the production of hollow bodies from solidifying mixed material, particularly concrete.

### BACKGROUND

1. Field of the Invention

The invention relates generally to a method for the automatic production of hollow bodies from a mixed material, particularly from concrete, and more particularly to an apparatus and method for rapidly changing out the mold to speed the molding process.

2. Background Discussion

For the production of concrete pipes for conduits and pipelines, pit linings or other relatively large molded bodies of concrete, the mold components are individually transported to the molding area and assembled to the complete mold in the molding area by means of appropriate damping and connecting means. The mold components generally comprise the inner mold core, mostly in the shape of a hollow cylinder, the shaking device installed in the inner space of the mold core, the bottom ingate or sprue, and also the exterior mold. If the production of another product series is to be started after the production of a first product series is completed, the mold components previously used need to be completely disassembled and replaced by corresponding mold components for the new product series. Generally it has been necessary to remove the mold components individually from the molding area of the facility and to transport them off as well as to introduce the individual mold components for the new product series into the molding area individually and to exactly align them with respect to each other and to fix them there. Particularly for large mold components these conversion works required a considerable amount of work and time. Since the production, of course, has to be interrupted during the conversion, considerable standstill times in the production process and a correspondingly reduced throughput result.

From International Publication WO 98/57786 for the simultaneous production of at least two concrete pipes, it is already known to arrange the exterior portions of the molds parallel to each other in a support stand with the aid of releasable coupling means and to vertically or laterally move them into or out of the molding area together with the support stands. By these measures the positioning and alignment of two or more exterior molds with respect to the respective stationary mold core is facilitated. Consequences on the conversion upon a change of the production from one product series to another are not caused.

### SUMMARY OF THE INVENTION

It is a primary purpose of the invention to reduce the work and time requirements necessary to change from one product series to another and to facilitate the complete conversion in series molding processes.

According to the invention the purpose is accomplished by assembling at least some of the mold components in an assembly area by means of releasable connecting means previous to a mold exchange and then transporting them into the molding area as a pre-mounted assembly. The mold components are then automatically disassembled in the molding area in correspondence with the production requirements and reassembled by an automatic operation of the connecting means and transported off from the molding area as an assembly previous to a new mold exchange.

As connecting means for the mold components, efficaciously automatically operable damping means are used which are directly installed on the respective mold components and the damping members of which are motor-driven, for example, by pressure means.

The individual mold components may efficaciously also be installed in an exchangeable housing in the assembly area and positioned in the molding area together with the exchangeable housing, the damping means between the individual mold components and the exchangeable housing being released and reactivated previous to the removal of the assembly in correspondence with the producing requirements in the molding area.

Another object of the invention is a facility for producing hollow bodies from a mixed material, particularly from concrete, having a support construction within and above a pit. The structure comprises a vertically movable exterior mold, a hollow mold core, at least one shaking device arranged in the mold core, a bottom sprue and an upper mold sprue, a filling device for introducing the unset concrete into the mold space, and handling devices for moving and positioning the mold components, as well as a control system for the production processes. The facility, according to the invention, is characterized in that at least part of the mold components required for one type of product is pre-mountable to form an independent assembly by means of clamping means at an assembly place outside of the support construction. The assembly can be transported into the mold position within the support construction and the clamping means are automatically releasable for disassembling the mold components in correspondence with the respective production requirements in the molding area and can be activated for removing the mold component as an assembly.

An efficacious embodiment of the facility according to the invention is characterized in that the mold means has its own clamping means for the direct assembly.

Another useful variant of the facility according to the invention is provided with a mobile exchangeable housing for securely accommodating the mold components, the housing remaining in a secured resting position within the support construction during the production process.

Preferably the above facility comprises motor-driven clamping means for releasably and individually connecting the exchangeable frame to the exterior mold, the mold core, the shaking device and, if required, at least one of the mold sprues.

One of the important advantages of the invention in practice resides in that the molds required for a new product series may be more or less completely assembled offsite during the production of a first product series. The same applies to the mold components of the mold used for the production of the first product series, which may also be independently assembled with the aid of automatic clamping and connecting means in the molding area after the completion of the production process. Therewith the conversion operations upon a product change are reduced to the removal of the previous assembly and the insertion of the new assembly into the molding area. The pre-installation of the new mold at an independent assembly area outside of the molding area, particularly due to the provision of the automated clamping and connecting means, results in a considerable simplification and facilitation of the installation works. This is particularly true for large and heavy mold components, while the production of the first product series may be unaffectedly continued during the pre-installation works. The use of automatic clamping means for releasably connecting the mold components to each other or to the exchangeable frame also enables a rapid and simple assembly of the components of the mold required for the production of the first product series within the molding area. All in all a considerable reduction of the time required is achieved through the use of this invention since a complete conversion process may be carried out in a fraction of the time previously required.

### BRIEF DESCRIPTION OF THE DRAWING

The objects, advantages, features and particularities of the invention will be more clearly understood from the following detailed description, when read in conjunction with the accompanying drawing, in which:

FIG. 1a is a schematic front view of the primary components of a facility constructed in accordance with the invention for the production of concrete pipes;

FIG. 1b is a schematic side view of the structure of FIG. 1a;

FIG. 2a is a schematic front view of the mold components installed in an exchangeable housing of the FIG. 1 apparatus;

FIG. 2b is a schematic side view of the apparatus of FIG. 2a;

FIG. 3a is a schematic exploded front view of the individual mold components and an exchangeable housing in accordance with the invention;

FIG. 3b is a schematic exploded side view of the apparatus of FIG. 3a; and

FIGS. 4a-d show different stages of a mold exchange.

### DETAILED DESCRIPTION OF THE PREFERRED EMBOIDMENTS

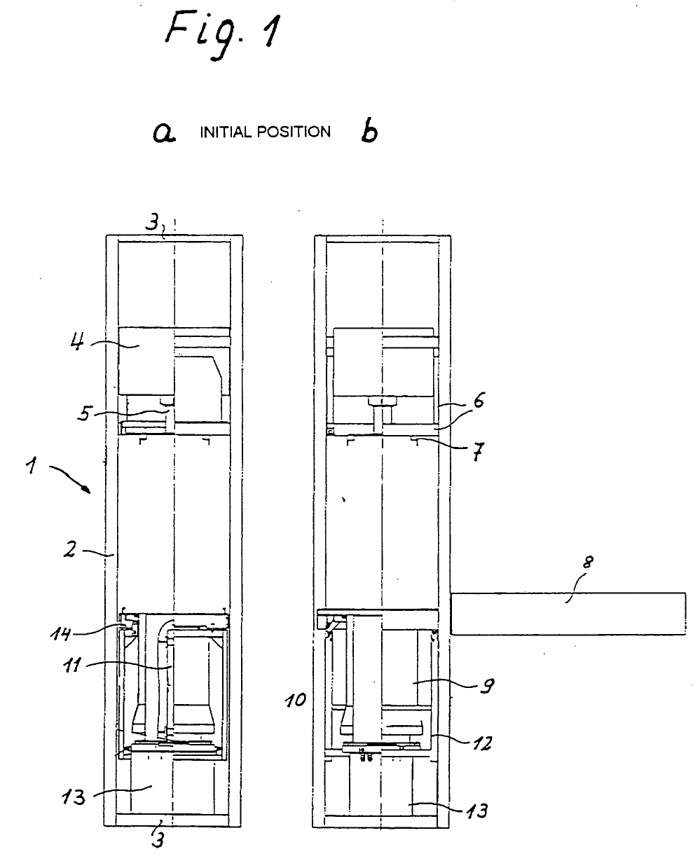

The facility shown in FIGS. 1a and 1b comprises main frame 1 of stabile vertical beams 2 which extend into a pit with their lower parts and are connected to a highly stiff support construction by means of lower and upper transverse bars. Pressing head 4 is shiftable along vertical guides (not shown) within the main frame, the pressing head comprising smoothing rod 5 on its bottom side and including connecting means 6 for holding upper mold sprue or ingate 7. In the normal position shown in FIG. 1 the actual mold is arranged below lateral introducing and detaching device 8. The mold consists of exterior mold 9, inner mold core 10, shaking device 11 disposed within hollow mold core 10 and connectable to the core wall by means of appropriate damping means, as well as exchangeable frame 12 separately connectable to mold core 10 and shaking device 11 by means of locking bolts. As may be seen from FIG. 1b, core substructure 13 is disposed under the mold core, the core substructure being supported on transverse beam 3 anchored in the pit foundation. The upper end portion of exterior mold 9 is releasably attached to mold frame 14 vertically shiftable within main frame 1.

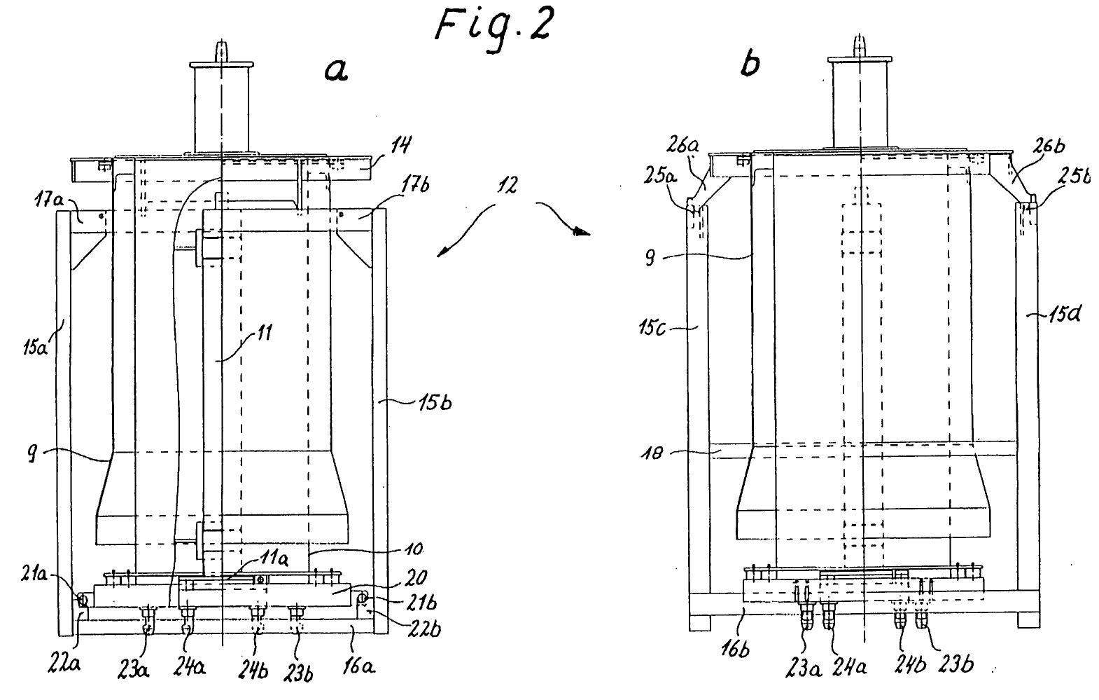

As can be seen from FIG. 2, the rectangular exchangeable frame consists of four vertical bars 15a-d being fixedly connected to each other by means of horizontal bars 16a and 16b, for example, at their lower ends. Vertical bars 15a, 15b comprise transverse beams 17a, 17b at their upper ends and vertical bars 15c, 15d are connected to each other by means of intermediate transverse bars 18.

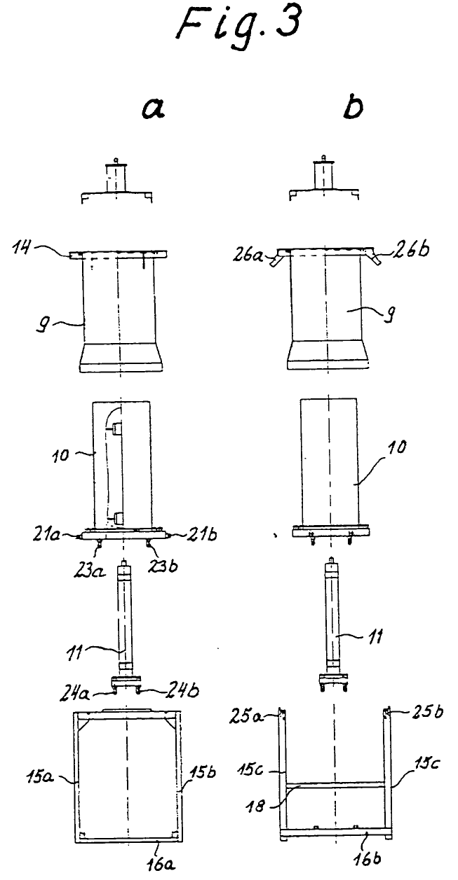

Mold core 10 is supported on transverse beams 20 having locking bolts 21a, 21b on both ends engaging with matching locking retainers 22a, 22b at the bottom corners of exchangeable housing frame 12. On the bottom side of transverse beams 20 are mounted vertical locking bolts 23a, 23b (see also FIG. 3).

Shaking device 11 is formed as a separate assembly and has a shaking drive 11a at its lower end on the bottom side of which are mounted two vertical locking bolts 24a, 24b.

On the upper ends of vertical bars 15c, 15d are locking retainers 25a, 25b by which transverse supports 26a, 26b can engage via locking bolts fixed to upper mold frame 14 for exterior mold 9. The operation, particularly of the locking members or locking bolts of the individual mold components and the retainer parts of the exchangeable housing, may be understood from FIGS. 3a, 3b.

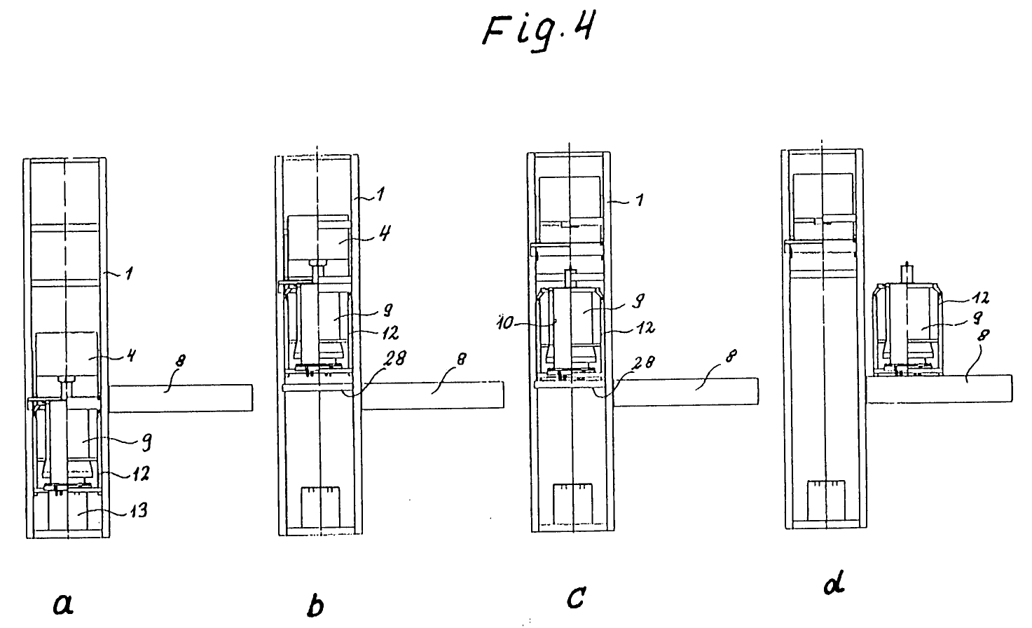

FIG. 4 shows four stages of a detachment process of a complete mold consisting of exterior mold, mold core and shaking device as well as the exchangeable frame according to the invention. Since every single mold component, that is, the exterior mold, the mold core and the shaking device, can be coupled to the exchangeable frame by means of respective separate locking members, it is possible to couple only individual mold components to the exchangeable housing, respectively, and to insert or to remove them. This possibility to select, depending on the operational condition, increases the flexibility of the complete production and conversion process.

In the condition shown in FIG. 4a, pressure head 4 is disposed in a lowered operation position as compared to the normal position shown in FIG. 1, and the mold is positioned within the pit below the floor level. In this position mold frame 14 and exchangeable frame 12 are coupled, and the conventional clamping means of the exterior mold, the mold core and the shaking device are released. Further, the locking bolts of the mold core are inserted into the corresponding retainers of the exchangeable housing and locked. In a corresponding manner, interlocking of the shaking device and the mold core is effected. After releasing smoothing rod 5 clamping a vertical upward movement of the pressure piston into the position shown in FIG. 4b is effected. In that position the pans latched to an assembly with the exchangeable frame are disposed in a position immediately above detaching device 8. In this lifted position support part 28 of detaching device 8 is laterally introduced into main frame 1 on which exchangeable frame 12, including exterior mold 9, mold core 10, shaking device 11 and smoothing rod 5, is placed in the position according to FIG. 4c. With a lateral travelling and shifting movement the assembly consisting of the exterior mold, the mold core, smoothing rod 5 and shaking device 11 is moved out of the main frame onto the platform of detaching area 8.

The invention is not limited to the illustrated embodiment. For example, the illustrated exchangeable frame 12 may be omitted. In this case the locking and clamping means, which can come into engagement with each other and thus enable the assembly of the individual mold components to an independently transportable assembly, are to be provided on the individual mold components.

1-10. (canceled)

11. A facility mounted at a pit at a support construction, for the production of hollow bodies from a mixed material, particularly from concrete, the facility including a control system, the facility comprising:
a support construction within and above a pit;
mold components forming a mold space, said mold components comprising:
a vertically movable exterior mold;
a vertically movable hollow mold core;
at least one shaking device disposed in the mold core; and
a bottom sprue and an upper mold sprue;
a filling device for filling the unset concrete into the mold space; and
handling devices for moving and positioning the mold components;
wherein at least the mold core and exterior mold required for a particular product type are configured to be pre-assembled to an independent assembly by means of clamping means outside of the support construction;
wherein said assembly is transportable into the molding position within the support construction; and
wherein the clamping means is releasable for taking apart the mold components in the molding area in accordance with the production processes, the removal of the mold components after the operation of the clamping means again being effected as an assembly.

12. The facility according to claim 11, wherein the mold components further comprise clamping means attached thereto for a direct assembly.

13. The facility according to claim 11, and further comprising a mobile exchangeable housing in which the respective mold components are mountable by means of separate clamping means and which remains in a secured resting position within the support construction during the production process.

14. The facility according to claim 13, and further comprising separate motor-driven or mechanically operable clamping means for releasably connecting the exchangeable housing with the exterior mold, the mold core, the shaking device and, if required, at least one of the mold sprues.

15. The facility according to claim 11, wherein the clamping means comprise locking bolts which are automatically brought into an engagement with corresponding locking retainers by vertical movements of the individual mold components.

16. The facility according to claim 13, wherein the clamping means comprise locking bolts which are automatically brought into an engagement with corresponding locking retainers by vertical movements of the individual mold components.

17. The facility according to claim 14, wherein the clamping means comprise locking bolts which are automatically brought into an engagement with corresponding locking retainers by vertical movements of the individual mold components.
